(19) United States
(12) Patent Application Publication
(10) Pub. No.: US 2026/0304226 A1
(43) Pub. Date: Oct. 1, 2026

(54) SYSTEMS AND METHODS FOR DYNAMIC NETWORK SLICE ADJUSTMENT FOR ACTIVE SESSIONS IN A WIRELESS NETWORK

(71) Applicant: Verizon Patent and Licensing Inc., Basking Ridge, NJ (US)

(72) Inventors: Kristen Sydney Young, Mine Hill, NJ (US); Kalyani Bogineni, Irving, TX (US); Lily Zhu, Parsippany, NJ (US); Sudhakar Reddy Patil, Flower Mound, TX (US); Raymond Wai-Man So, San Ramon, CA (US)

(73) Assignee: Verizon Patent and Licensing Inc., Basking Ridge, NJ (US)

(21) Appl. No.: 19/093,052

(22) Filed: Mar. 27, 2025

(51) Int. Cl. H04W 28/08; H04L 45/74

(52) U.S. Cl. CPC H04W 28/0925; H04L 45/74

(57) ABSTRACT

A system described herein may identify a first network slice that serves a first communication session associated with a User Equipment (“UE”). The first communication session may be associated with a particular identifier. The system may identify a particular set of traffic attributes associated with a slice re-routing policy; identify that the slice re-routing policy indicates a second network slice, of the plurality of network slices, that is different from the first network slice; and output the slice re-routing policy to the UE based on identifying that the slice re-routing policy indicates the different second network slice. Providing the policy may include outputting the set of traffic attributes and an indication of the second network slice. The UE may output uplink traffic, meeting the set of traffic attributes, via a second communication session associated with the second network slice. The uplink traffic may include the particular identifier.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may implement different network slices, which may be associated with discrete sets of access policies, Quality of Service (“QoS”) parameters, or the like. In some implementations, a communication session (e.g., a protocol data unit (“PDU”) session) between a UE and another device, such as an application server, via the wireless network may be served via by a particular network slice, where such network slice is designated at the time of communication session establishment.

### BRIEF DESCRIPTION OF THE DRAWINGS

FIG. 1 illustrates an example overview of one or more embodiments described herein;

FIG. 2 illustrates example data structures that reflect an implementation of a slice re-routing policy, in accordance with some embodiments;

FIG. 3 illustrates an example of routing uplink traffic in accordance with a slice re-routing policy, in accordance with some embodiments;

FIG. 4 illustrates an example of routing downlink traffic in accordance with a slice re-routing policy, in accordance with some embodiments;

FIG. 5 illustrates an example of dynamically using multiple network slices for traffic having different attributes, in accordance with some embodiments;

FIG. 6 illustrates an example signal flow for implementing a slice re-routing policy, in accordance with some embodiments;

FIG. 7 illustrates an example process for implementing a slice re-routing policy, in accordance with some embodiments;

FIGS. 8 and 9 illustrate example environments in which one or more embodiments, described herein, may be implemented;

FIG. 10 illustrates an example arrangement of a radio access network (“RAN”), in accordance with some embodiments; and

FIG. 11 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

A wireless network may provide connectivity between a UE and another device, such as an application server, another UE, and/or some other suitable device or system. For the sake of simplicity, examples are described below in the context of communications between a UE and a particular application server. A communication session, such as a PDU session, may be used to route traffic between the UE and the application server via the wireless network. In the course of establishing the communication session, the wireless network may assign locator information that may be used by the application server to communicate with the UE, such as an Internet Protocol (“IP”) address (e.g., an “external” or “public” IP address). Additionally, in the course of establishing the communication session, the wireless network may assign a particular network slice to the communication session. In this manner, in certain implementations, the IP address may be “tied to” the communication session and may, in turn, be “tied to” the particular network slice.

Situations may occur in which traffic, associated with a particular network slice (e.g., traffic associated with a particular communication session), may be better served by a different network slice. For example, a communication session may be established between a UE and an application server via a first network slice (e.g., a “default” network slice) that is associated with a first set of QoS parameters (e.g., a first set of QoS thresholds, such as maximum latency thresholds, minimum throughput thresholds, etc.). In one scenario, the first network slice may become congested or may otherwise experience performance degradations, such that the first network slice is no longer able to meet the first set of QoS parameters. In another scenario, performance requirements of a service provided by the application server to the UE may change, such that the first set of QoS parameters are inadequate (e.g., QoS parameters of the service may be more stringent than the first set of QoS parameters). In yet another scenario, the UE may gain access or authorization to a second network slice after establishment of the communication session. In another scenario, the wireless network may determine based on some other suitable criteria or conditions that the traffic between UE and the application server should be served by the second network slice in lieu of the first network slice, with which the existing communication session is associated.

Embodiments described herein provide for the dynamic adjustment of which network slice, out of a set of network slices implemented by a wireless network, serves particular traffic, such as traffic between a UE and application server or other suitable device. The dynamic adjustment may include associating the particular traffic with a second network slice that is different from a first network slice with which an existing communication session is associated. As discussed herein, the dynamic adjustment may be performed without changing locator information associated with the UE, such as a public or external IP address. In this manner, the application server may not need to re-establish a connection with the UE or otherwise account for a different IP address when providing service to the UE. As such, QoS parameters (e.g., reduced latency, increased throughput, etc.) or other attributes of the second network slice may be applied to traffic between the UE and the application server, without the potential disruption in service that may be caused by establishing a new communication session (e.g., a new PDU session) or otherwise changing the locator information of the UE.

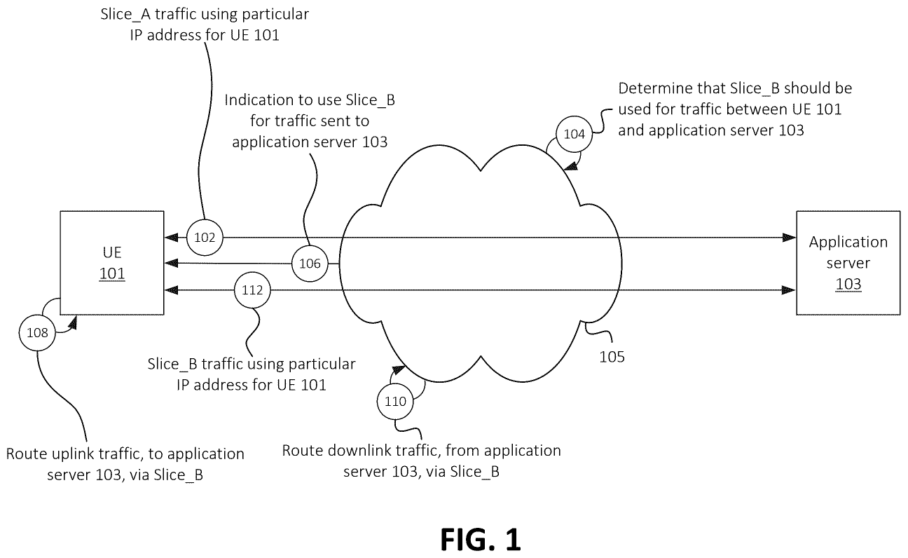

As shown in FIG. 1, for example, assume that UE 101 receives a service from application server 103 via wireless network 105. In other words, UE 101 may be communicatively coupled to wireless network 105, such as via a RAN of wireless network 105, such that wireless network 105 is able to route traffic between UE 101 and one or more other devices or systems, such as application server 103. In this example, assume that UE 101 and application server 103 are associated with a particular communication session (e.g., a particular PDU session) that is associated with a first network slice (represented as “Slice_A”). In this manner, Slice_A of wireless network 105 may serve (at 102) traffic sent between UE 101 and application server 103. As discussed above, Slice_A may be associated with a particular set of QoS parameters, may be implemented by a particular set or subset of network elements of wireless network 105 (e.g., particular Network Function (“NF”) instances), or the like.

At some point, wireless network 105 may determine (at 104) that a different network slice (represented as “Slice_B”) should be used to serve traffic between UE 101 and application server 103. For example, as discussed above, wireless network 105 may determine that Slice_A is congested, that UE 101 has gained access to Slice_B (e.g., after the communication session between UE 101 and application server 103 was established), that service requirements (e.g., QoS thresholds, Service Level Agreements (“SLAs”), etc.) of traffic between UE 101 and application server 103 exceed QoS parameters of Slice_A, or the like. In one example scenario, application server 103 may offer various types of services (e.g., voice call services and text-based messaging services), and a service not used by UE 101 at the time of establishment of the communication session (e.g., a voice call service) may be used or invoked at a time later than the establishment of the communication session.

In accordance with some embodiments, and as discussed below, wireless network 105 may indicate (at 106) to UE 101 that UE 101 should send traffic, associated with the service provided by application server 103, via a Slice_B communication session (e.g., rather than using the communication session that is associated with Slice_A). In other words, wireless network 105 may provide (at 106) a slice re-routing policy, which may specify a particular network slice (i.e., Slice_B, in this example) that should be used for traffic meeting certain attributes. As discussed herein, such traffic may be associated with a previously established communication session that is associated with a different slice (i.e., Slice_A, in this example).

Wireless network 105 may, for instance, provide control signaling, such as Non-Access Stratum (“NAS”) signaling, to UE 101 indicating that such traffic should be sent via a Slice_B communication session. In some embodiments, the control signaling may indicate traffic attributes, a Traffic Flow Template (“TFT”), and/or other suitable conditions or criteria that specify which traffic should be sent via Slice_B. In this example, such traffic attributes may include an identifier or locator of application server 103 (e.g., an IP address), a traffic and/or service type (e.g., voice, data, gaming, etc.), a protocol (e.g., Transmission Control Protocol (“TCP”), User Datagram Protocol (“UDP”), or the like), and/or other suitable information. In some embodiments, the traffic attributes may include or may be based on a “five-tuple,” which may include an IP address of a first endpoint of the communication session (e.g., an IP address of UE 101), a port number of the first endpoint, an IP address of a second endpoint of the communication session (e.g., an IP address of application server 103), a port number of the second endpoint, and a protocol with which the communication session is associated. In such embodiments, the slice re-routing policy may specify a particular network slice that should be used for traffic that meets the five-tuple information.

As discussed below, one or more elements of wireless network 105 (e.g., a user plane traffic gateway, such as a User Plane Function (“UPF”)) may also be configured with the traffic attribute information as well as an indication that such traffic should be served by Slice_B. That is, one or more elements of wireless network 105 may also be configured with the same slice re-routing policy.

Based on receiving (at 106) the indication (e.g., based on receiving or maintaining the slice re-routing policy), UE 101 may request the initiation of a communication session (e.g., a PDU session) with network 105 in accordance with the slice re-routing policy. For example, UE 101 may request the establishment of a PDU session that is associated with (e.g., served by) Slice_B. Additionally, or alternatively, UE 101 may identify a pre-existing communication session that is associated with Slice_B (e.g., in the event that such communication session had been established prior to wireless network 105 determining that Slice_B should serve traffic between UE 101 and application server 103).

UE 101 may accordingly route (at 108) uplink traffic, that meets the traffic attributes associated with the slice re-routing policy (e.g., traffic to be sent to application server 103, traffic associated with a particular service or type, traffic associated with a particular protocol, traffic meeting a particular five-tuple, etc.) to application server 103 via the Slice_B communication session. As discussed below, routing such traffic may include encapsulating or otherwise preserving the IP address of UE 101, which was assigned to UE 101 with respect to the previously established Slice_A communication session. Thus, when forwarding the uplink traffic to application server 103, wireless network 105 may continue using (at 112) the same IP address for UE 101 as the source of the uplink traffic, thus maintaining continuity of connection from the standpoint of application server 103. That is, from the standpoint of application server 103, traffic sent (at 102) to application server 103 via Slice_A (e.g., before the re-routing policy is implemented) as well as traffic sent (at 112) to application server 103 via Slice_B (e.g., after the re-routing policy is implemented) may preserve the same IP address, and application server 103 may be “unaware” of the change in serving network slice for the traffic.

Similarly, when receiving (at 110) downlink traffic that meets the particular set of traffic attributes (e.g., traffic from application server 103, traffic associated with a particular service or type, traffic associated with a particular protocol, etc.), wireless network 105 may provide such traffic to UE 101 via the Slice_B communication session. In some embodiments, forwarding the traffic to UE 101 via the Slice_B communication session may include replacing an IP address of UE 101, as provided by application server 103, with a different IP address. For example, application server 103 may indicate the IP address of UE 101, which was previously assigned with respect to the Slice_A communication session, as the destination of the downlink traffic. When identifying that such traffic should be routed via the Slice_B communication session, wireless network 105 may use the IP address of UE 101, as assigned during the establishment of the Slice_B communication session. In this manner, UE 101 and application server 103 may communicate (at 112) via Slice_B, without application server 103 needing to perform any reconfiguration or other techniques to account for the change in network slice (e.g., where such reconfiguration may lead to perceptible service disruptions and a degraded user experience, degraded QoS or performance metrics, degraded Quality of Experience (“QoE”), or the like).

Further, as discussed below, embodiments described herein may provide for traffic, having different attributes but associated with the same application server 103, to be dynamically served by different network slices. For example, the same application server 103 may provide voice call services, web browsing services, gaming services, or the like. Embodiments described herein may provide for different serves, associated with the same application server 103, to be routed via different network slices, without the need to re-establish different communication sessions, provide updated UE IP addresses to application server 103, etc.

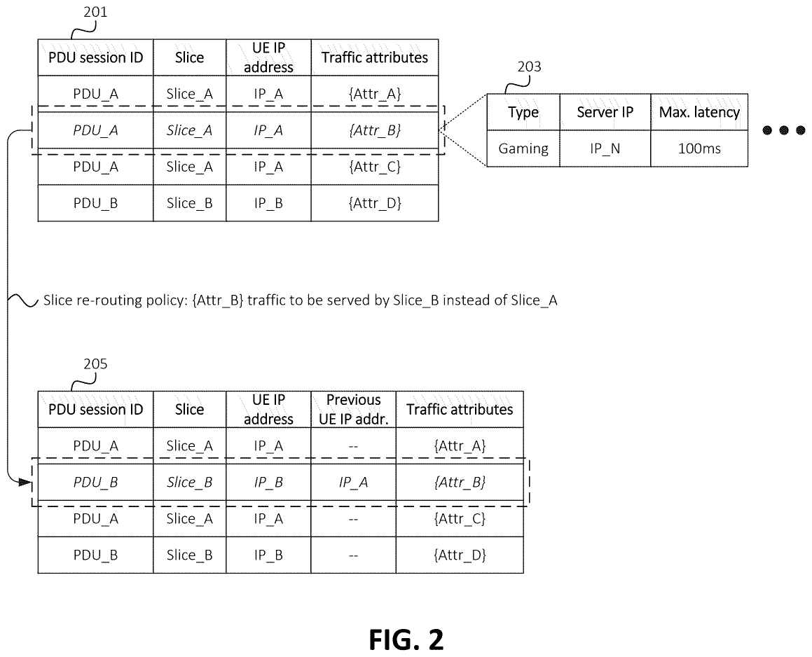

FIG. 2 illustrates example data structures 201, 203, and 205 that reflect routing and/or re-routing of traffic based on techniques described herein. Data structure 201, for example, may reflect routing of traffic (e.g., by UE 101 and/or by one or more elements of wireless network 105, such as a UPF) prior to the establishment of a slice re-routing policy. In this example, data structure 201 refers to traffic associated with a particular UE 101. As shown, for example, data structure 201 includes information for two different communication sessions (e.g., two PDU sessions), referred to as “PDU_A” and “PDU_B.” In this example, PDU_A is associated with (e.g., served by) a first network slice (Slice_A), and PDU_B is associated with a second network slice (Slice_B). Additionally, UE 101 may have been assigned a first IP address (referred to as “IP_A”) for the first communication session, and may have been assigned a second IP address (referred to as “IP_B”) for the second communication session. Generally (e.g., in the absence of an applicable slice re-routing policy), when receiving traffic (e.g., downlink traffic) indicating IP_A, wireless network 105 may route such traffic to UE 101 via PDU_A, and when receiving traffic indicating IP_B, wireless network 105 may route such traffic to UE 101 via PDU_B.

Additionally, data structure 201 may indicate traffic attributes, TFTs, and/or other conditions or criteria which may be used to indicate which respective network slices serve respective traffic meeting such attributes. In this example, the set of attributes “{Attr_B}” may be represented by data structure 203. In this example, data structure 203 indicates that {Attr_B} includes “gaming” traffic, that an endpoint of the traffic is a particular device or system having an IP address represented as “IP_N,” and that QoS parameters or SLAs of the traffic indicates a maximum latency of 100 ms. In practice, additional, fewer, or different parameters or information may be used to indicate attributes of particular traffic.

Data structure 205 represents the implementation of a slice re-routing policy (e.g., as indicated or determined by wireless network 105, as discussed above). For example, UE 101 may maintain some or all of the information shown in data structure 205 in order to implement the slice re-routing policy. Additionally, or alternatively, one or more elements of wireless network 105 (e.g., a UPF and/or some other NF of wireless network 105) maintain some or all of the information shown in data structure 205 in order to implement the slice re-routing policy. Traffic meeting a particular set of traffic attributes (i.e., {Attr_B}, in this example) may have been indicated in a slice re-routing policy. Specifically, for example, the slice re-routing policy may indicate that traffic meeting {Attribs_B} (e.g., having the same traffic or service type as indicated in {Attribs_B}, having the same endpoint or server IP address as indicated in {Attribs_B}, having the same set of QoS parameters as indicated in {Attribs_B}, etc.) should be served via Slice_B. As reflected in FIG. 2, this may be an adjustment of the network slice for traffic meeting {Attribs_B}, inasmuch as the slice re-routing policy indicates a different network slice (i.e., Slice_B) than was previously associated with the same traffic (e.g., as indicated in data structure 201).

In this example, PDU_B may have already been previously established, and thus UE 101 may have a pre-existing communication session established that is associated with (e.g., served by) Slice_B. In scenarios where PDU_B has not previously been established, UE 101 may request the establishment of PDU_B (e.g., by issuing a PDU Session Establishment Request or some other suitable type of message or request to wireless network 105), in order to receive service via Slice_B.

As shown, the IP address for UE 101 with respect to PDU_B (i.e., IP_B) may be different from the IP address for UE 101 with respect to PDU_A (i.e., IP_A). Thus, when traffic meeting {Attribs_B} is re-routed to Slice_B, IP_B may be used to route such traffic via PDU_B. As further shown, data structure 205 may further include information specifying that traffic meeting {Attribs_B}, which has been re-routed to Slice_B, was previously associated with IP_A. The association of such traffic with its previous IP address may facilitate the preservation of the same IP address (i.e., IP_A) for UE 101 from the standpoint of a device or system (e.g., application server 103) that communicates with (e.g., provides one or more services to) UE 101.

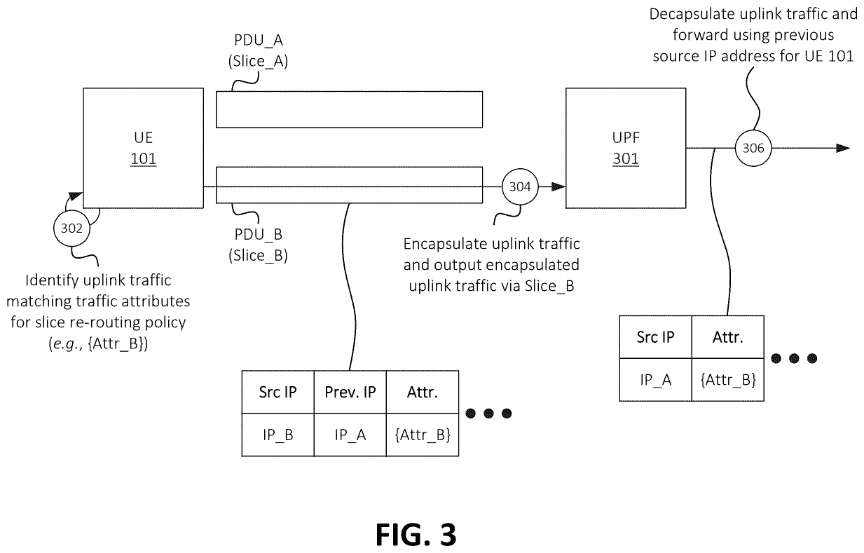

For example, as shown in FIG. 3, UE 101 may identify (at 302) uplink traffic that matches a particular set of traffic attributes for a slice re-routing policy (e.g., {Attr_B}, continuing with the above example). For example, UE 101 may identify traffic output by a particular application, where such traffic includes or specifies a destination endpoint (e.g., an IP address of a particular application server 103), a particular traffic or service type, a particular protocol, a particular QoS parameter or threshold, and/or otherwise matches, meets, satisfies, etc. the particular set of traffic attributes of the slice re-routing policy (e.g., {Attr_B}). UE 101 may identify that such traffic should accordingly be sent via PDU_B, as PDU_B is associated with Slice_B that is specified in the slice re-routing policy.

When outputting (at 304) the traffic via PDU_B, UE 101 may include previous IP information for the traffic. For example, as noted above with respect to data structure 205, UE 101 may maintain information associating the particular set of attributes {Attr_B} with the previous IP address (e.g., where such previous IP address is associated with a communication session that is associated with a previously assigned network slice). UE 101 may include the previous IP address, such as in a header or sub-header, of the uplink traffic. In one example embodiment, UE 101 may encapsulate one or more packets (e.g., IP packets) of uplink traffic meeting {Attr_B}, which specify a source IP address of IP_A, into one or more packets of uplink traffic which specify a source IP address of IP_B.

That is, in an example embodiment, an application executing on UE 101 may output uplink traffic to application server 103, where such uplink traffic specifies a source IP address of IP_A (e.g., based on a previous communication session establishment of PDU_A in which UE 101 was assigned IP_A with respect to PDU_A). A modem, network interface, operating system, an application programming interface (“API”), and/or other suitable element of UE 101 may identify that the traffic meets {Attr_B} (and therefore satisfies the example slice re-routing policy), and may accordingly encapsulate the uplink traffic into packets specifying IP_B as the source of the traffic. UE 101 may accordingly route, send, output, etc. such traffic (e.g., encapsulated traffic) via PDU_B. In some embodiments, UE 101 may include one or more flags, indicators, etc. in the traffic (e.g., as header information) indicating that the traffic is associated with a slice re-routing policy, and/or may otherwise specify that the traffic is associated with IP_A (e.g., the previous IP address).

As further shown, the uplink traffic may be received by a particular element of wireless network 105, such as UPF 301. UPF 301 may identify that the uplink traffic is associated with a slice re-routing policy (e.g., the same slice re-routing policy implemented by UE 101 for traffic meeting {Attr_B}). For example, the traffic may include one or more flags, indictors, etc. as discussed above. In some embodiments, UPF 301 may identify additional or different information, such as a destination IP address, a protocol, etc. associated with the traffic in order to identify that the traffic was routed based on or otherwise subject to a slice re-routing policy. Based on identifying that the traffic is associated with a slice re-routing policy, UPF 301 may decapsulate (at 306) the traffic and/or otherwise identify the previous IP address (i.e., IP_A, in this example) associated with the traffic. For example, UPF 301 may remove, strip, etc. a header that included IP_B. In this example, UPF 301 forwards the traffic (e.g., to application server 103) with IP_A as a source IP address for the traffic. In other implementations, UPF 301 may perform further address translation, mapping, routing, etc. (e.g., based on IP_A) when forwarding the traffic towards its destination (e.g., application server 103 via one or more networks such as the Internet).

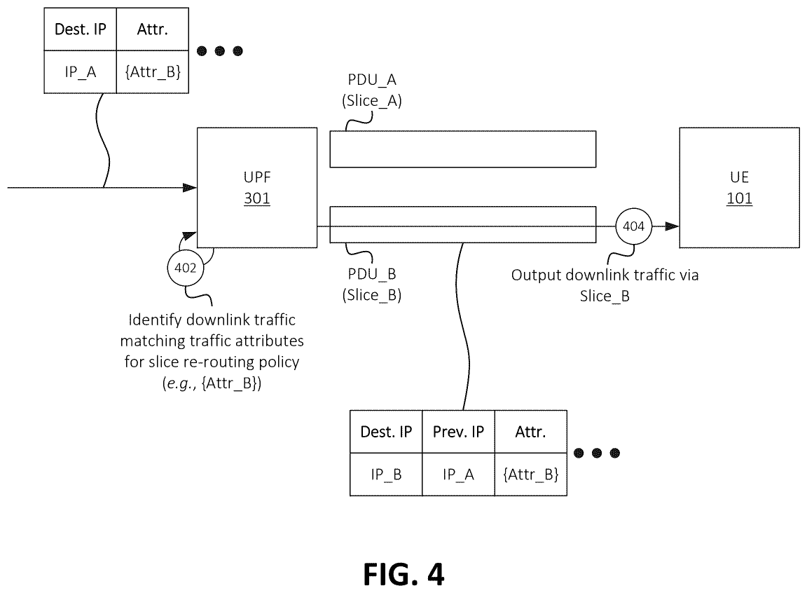

FIG. 4 illustrates the implementation of a slice re-routing policy, in accordance with some embodiments, for traffic in the downlink direction (e.g., traffic to UE 101). As shown, UPF 301 may identify (at 402) that downlink traffic, to be sent to UE 101 (e.g., indicating IP_A as a destination) meets conditions, criteria, etc. of the slice re-routing policy (e.g., {Attrs_B}, continuing with the above example). The downlink traffic may have been received from, for example, application server 103 (e.g., via one or more networks such as the Internet) or some other suitable source.

UPF 301 may encapsulate the downlink traffic into one or more packets that specify IP_B as the destination, based on identifying that the downlink traffic meets the particular set of attributes associated with the slice re-routing policy. As discussed above, UPF 301 may, in some embodiments, include an indication of the previous or original IP address indicated as the destination in the traffic (i.e., IP_A, in this example). In some embodiments, UPF 301 may include an indicator, flag, etc. specifying that the downlink traffic is associated with a slice re-routing policy.

In other embodiments, UPF 301 may replace the original destination IP address (e.g., IP_A) with the IP address associated with the slice indicated in the slice re-routing policy (e.g., IP_B). For example, in such embodiments, UPF 301 may forgo including an indication of the previous IP address (e.g., IP_A) when routing the downlink traffic. In any event, the traffic may be output, routed, forwarded, etc. (at 404) to UE 101 (e.g., via a RAN and/or other elements of wireless network 105) via PDU_B. For example, IP_B may be used as a destination of the traffic in order to indicate, to elements of wireless network 105, that the traffic is to be served by Slice_B (e.g., is to be sent via PDU_B).

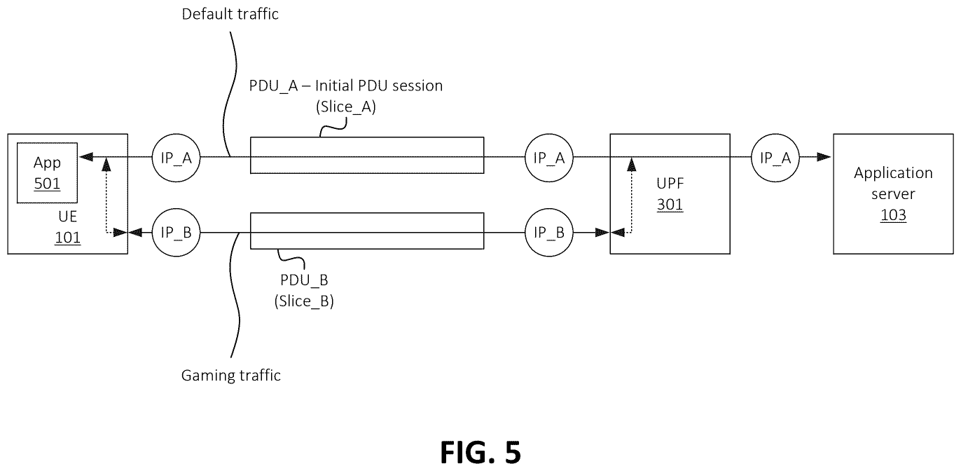

In some embodiments, as discussed above, traffic associated with the same application server 103 may be subject to different slice routing or re-routing policies. For example, as shown in FIG. 5, assume that some traffic associated with (e.g., sent to or received from) application server 103 is associated with a first type (e.g., “default” traffic) and that other traffic associated with application server 103 is associated with a second type (e.g., “gaming” traffic). Assume that PDU_A was established as an “initial” PDU session for routing communications between UE 101 and application server 103 via wireless network 105. In one example, PDU_A may have been established when UE 101 initializes, starts up, executes, etc. a particular application 501 that is configured to communicate with application server 103. For example, application 501 may be a “client-side” application and application server 103 may provide “server-side” functionality for application 501.

At some subsequent point in time (e.g., seconds later, minutes later, etc.), application 501 may request or otherwise receive a gaming service from application server 103, such as based on a user selection via application 501, a remote invitation from another user or UE, etc. As discussed above, wireless network 105 and/or UE 101 may identify that the gaming traffic meets a particular slice re-routing policy, and that the gaming traffic should be served by Slice_B instead of Slice_A. As discussed above, UE 101 may request the establishment of, and/or may otherwise use, PDU_B in order to receive service via Slice_B.

As similarly discussed above, UE 101 may route uplink gaming traffic (e.g., traffic that is subject to the slice re-routing policy) via PDU_B, which may include using IP_B (e.g., in order to route the traffic via PDU_B) as well as indicating IP_A as the previous IP address. UPF 301 may accordingly receive the uplink gaming traffic and indicate IP_A as the source of the uplink gaming traffic when outputting the gaming traffic to application server 103.

Additionally, UE 101 may continue to route other traffic (e.g., referred to as “default” traffic), which does not meet the slice re-routing policy, via PDU_A. For such traffic, UPF 301 may forward the traffic to application server 103 with its original source IP address (and/or otherwise based on the original source IP address). That is, in this example, all traffic received by application server 103, originating from UE 101, may include or may be based on IP_A.

As also discussed above, UPF 301 may route downlink gaming traffic (e.g., traffic that is subject to the slice re-routing policy) via PDU_B, which may include using IP_B (e.g., in order to route the traffic via PDU_B) as a destination of the traffic. In some embodiments, such traffic may also include an indication of IP_A as the previous IP address. UE 101 may accordingly receive the downlink gaming traffic, and may provide such traffic to application 501. In some embodiments, prior to providing the downlink gaming traffic to application 501, UE 101 (e.g., a modem, a network interface, an operating system, etc.) may remove, strip, replace, etc. IP_B and may provide IP_A with the traffic to application 501. Similarly, UPF 301 may forward default traffic to UE 101 via PDU_A, without using IP_B (e.g., without replacing IP_A with IP_B, without encapsulating the traffic using IP_B, etc.).

In this manner, UE 101 and application server 103 may communicate via different network slices simultaneously, which may include UE 101 receiving different types of services, with differing QoS parameters or SLAs, from application server 103. Additionally, slice re-routing policies may be changed dynamically or “on the fly,” thus providing for flexibility in the implementation of wireless network 105.

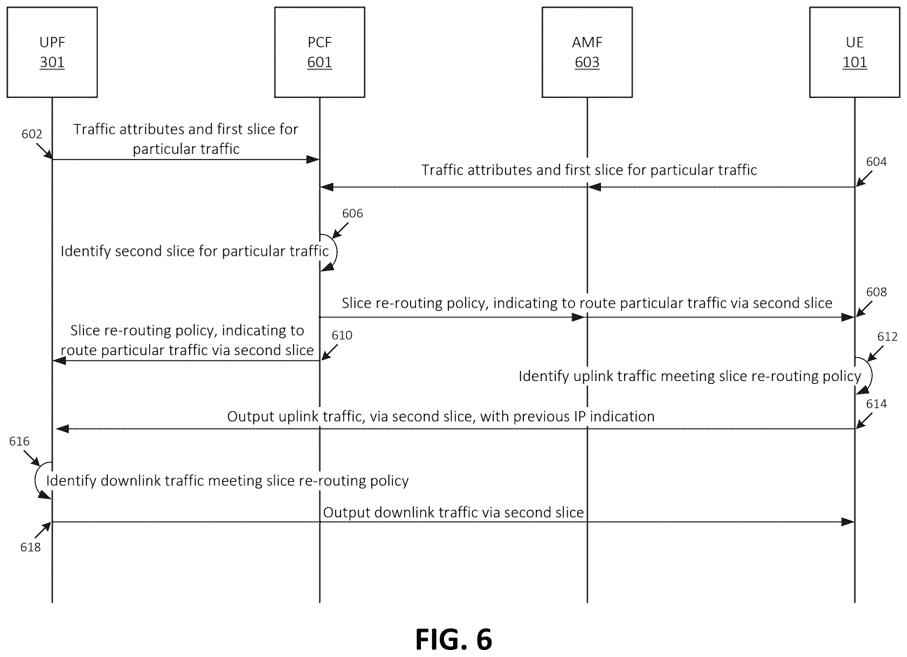

FIG. 6 illustrates an example signal flow for implementing a slice re-routing policy, in accordance with some embodiments. As shown, a policy element of wireless network 105, such as Policy Control Function (“PCF”) 601, may receive (at 602 and/or 604) an indication of a set of traffic attributes and a first network slice, associated with traffic or a communication session associated with UE 101. For example, UPF 301 may provide (at 602) such information, and/or UE 101 may provide (at 604) such information.

In some embodiments, communications between UE 101 and PCF 601 may include communications between UE 101 and AMF 603 and communications between AMF 603 and PCF 601. For example, UE 101 and AMF 603 may communicate via NAS signaling, and AMF 603 may communicate with PCF 601 via a Service-Based Interface (“SBI”) or other suitable communication pathway.

In some embodiments, UPF 301 and/or UE 101 may provide (at 602 and/or 604) the traffic attributes and the indication of the first network slice as part of, or subsequent to, an establishment of a communication session (e.g., a PDU session). In some embodiments, PCF 601 may output a request, to UPF 301 and/or UE 101, for traffic attribute information and/or network slice information associated with one or more communication sessions associated with UE 101. In some embodiments, PCF 601 may periodically or intermittently receive, monitor, etc. traffic attribute information and/or network slice information associated with one or more communication sessions associated with UE 101.

PCF 601 may identify (at 606) a second network slice for the particular traffic. For example, PCF 601 may receive (e.g., from a Network Data Analytics Function (“NWDAF”) or some other suitable source), network analytics information (e.g., performance monitoring information, congestion information, QoS or QoE metrics, or the like), slice re-routing policies, or other suitable information based on which PCF 601 identifies that the particular traffic (e.g., meeting particular attributes) should be served by the second network slice.

PCF 601 may accordingly output (at 608) the slice re-routing policy to UE 101. For example, PCF 601 may provide the slice re-routing policy to AMF 603, which may provide the slice re-routing policy (e.g., via NAS signaling) to UE 101. Additionally, PCF 601 may output (at 610) the slice re-routing policy to UPF 301. In this manner, and as discussed above, UE 101 may identify (at 612) uplink traffic that meets attributes specified in the slice re-routing policy, and output (at 614) the uplink traffic to UPF 301 via the second slice (e.g., via a particular communication session, such as a PDU session, that is served by the second slice). As discussed above, such traffic may include a previous IP indication, such that UPF 301 is able to use the previous IP address when forwarding the uplink traffic to its destination (e.g., application server 103). Similarly, UPF 301 may identify (at 616) downlink traffic that meets the particular set of attributes, and may provide (at 618) the downlink traffic via the second slice. As discussed above, the downlink traffic may, in some embodiments, include the previous IP indication, such that UE 101 is able to use the previous IP address when providing the downlink traffic to an application (e.g., application 501) executing at UE 101.

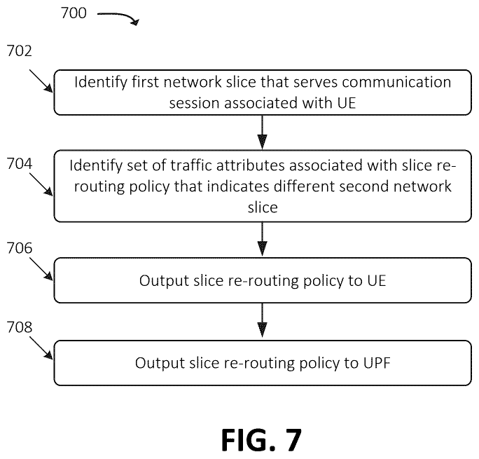

FIG. 7 illustrates an example process 700 for implementing a slice re-routing policy. In some embodiments, some or all of process 700 may be performed by PCF 601. In some embodiments, one or more other devices may perform some or all of process 700 in concert with, and/or in lieu of, PCF 601.

As shown, process 700 may include identifying (at 702) a first network slice that serves a communication session associated with a particular UE 101. For example, as discussed above, PCF 601 may receive communication session information, including serving slice information, from UE 101, UPF 301, and/or some other suitable source. As discussed above, PCF 601 may receive such information as part of a PDU session establishment procedure, a PDU session modification procedure, a monitoring procedure, and/or in some other suitable manner.

Process 700 may further include identifying (at 704) a set of traffic attributes associated with a slice re-routing policy. As discussed above, PCF 601 may receive or maintain one or more slice re-routing policies, which indicate traffic attributes (e.g., endpoint IP address information, traffic or service type, protocol, QoS parameters, etc.) as well as a particular network slice that should serve traffic meeting such attributes. For example, in some embodiments, PCF 601 may receive, determine, etc. the slice re-routing policy based on analytics or events, such as determining that the first network slice is not able to provide at least a threshold level of QoS or performance with respect to the traffic. The network slice indicated in the slice re-routing policy may be different network slice (e.g., a second network slice) than the first network slice that serves the established communication session associated with UE 101.

Process 700 may additionally include outputting (at 706) the slice re-routing policy to UE 101. As discussed above, UE 101 may use the slice re-routing policy by outputting uplink traffic, that meets the particular set of attributes, via the second network slice (e.g., via a second communication session that is associated with the second network slice), and may further include an identifier (e.g., an IP address) that was assigned to UE 101 as part of establishing the first communication session. That is, UE 101 may be associated with a first identifier that is associated with the first communication session (e.g., a first IP address assigned to UE 101 as part of establishment of the first communication session) as well as a second identifier that is associated with the second communication session (e.g., a second IP address assigned to UE 101 as part of establishment of the second communication session). As discussed above, including the first identifier (e.g., a previous IP address) may facilitate wireless network 105 (e.g., UPF 301) forwarding the traffic to its destination (e.g., application server 103), using the first identifier when indicating the source of the traffic. In this manner, although the traffic is now served by the second network slice within wireless network 105, application server 103 may not need to be “aware” of the re-routing of the traffic and/or may not need to reconfigure communications with UE 101 using the second identifier (e.g., the second IP address associated with the second communication session).

Process 700 may also include outputting (at 708) the slice re-routing policy to UPF 301. For example, as discussed above, UPF 301 may use the slice re-routing policy by outputting downlink traffic, that meets the particular set of attributes, via the second network slice (e.g., via the second communication session that is associated with the second network slice). In some embodiments, UPF 301 may further include the identifier (e.g., the previous IP address) with the downlink traffic, which may be used by UE 101 to route the traffic to application 501, and/or which may be provided to application 501 with the downlink traffic.

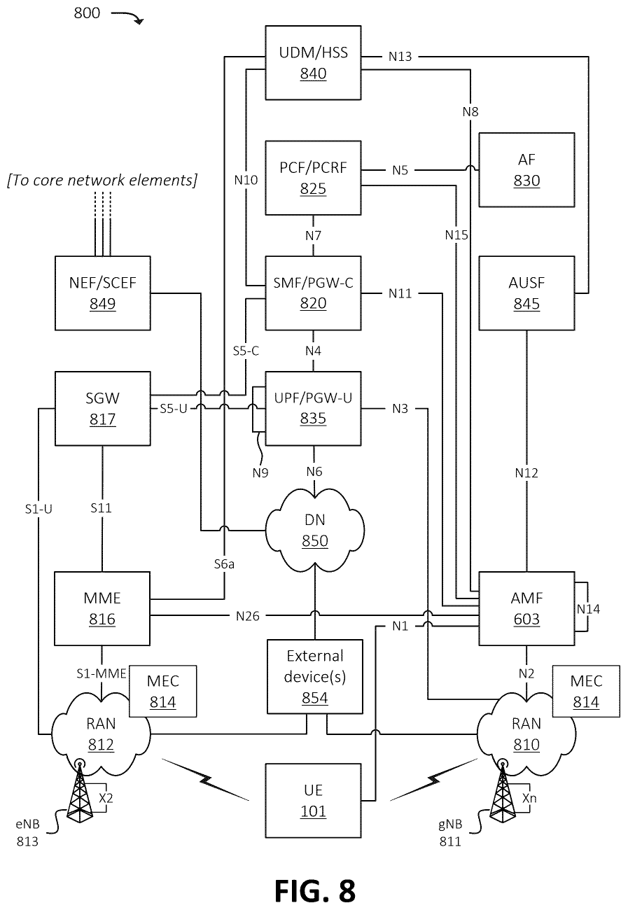

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 800 may represent or may include a 5G core (“5GC”). As shown, environment 800 may include UE 101, RAN 810 (which may include one or more Next Generation Node Bs (“gNBs”) 811), RAN 812 (which may include one or more evolved Node Bs (“eNBs”) 813), and various network functions such as Access and Mobility Management Function (“AMF”) 603, Mobility Management Entity (“MME”) 816, Serving Gateway (“SGW”) 817, Session Management Function (“SMF”)/Packet Data Network (“PDN”) Gateway (“PGW”)-Control plane function (“PGW-C”) 820, PCF/Policy Charging and Rules Function (“PCRF”) 825, Application Function (“AF”) 830, User Plane Function (“UPF”)/PGW-User plane function (“PGW-U”) 835, Unified Data Management (“UDM”)/Home Subscriber Server (“HSS”) 840, Authentication Server Function (“AUSF”) 845, and Network Exposure Function (“NEF”)/Service Capability Exposure Function (“SCEF”) 849. Environment 800 may also include one or more networks, such as Data Network (“DN”) 850. Environment 800 may include one or more additional devices or systems communicatively coupled to one or more networks (e.g., DN 850), such as one or more external devices 854.

The example shown in FIG. 8 illustrates one instance of each network component or function (e.g., one instance of SMF/PGW-C 820, PCF/PCRF 825, UPF/PGW-U 835, UDM/HSS 840, and/or AUSF 845). In practice, environment 800 may include multiple instances of such components or functions. For example, in some embodiments, environment 800 may include multiple “slices” of a core network, where each slice includes a discrete and/or logical set of network functions (e.g., one slice may include a first instance of AMF 603, SMF/PGW-C 820, PCF/PCRF 825, and/or UPF/PGW-U 835, while another slice may include a second instance of AMF 603, SMF/PGW-C 820, PCF/PCRF 825, and/or UPF/PGW-U 835). The different slices may provide differentiated levels of service, such as service in accordance with different Quality of Service (“QoS”) parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Additionally, one or more elements of environment 800 may be implemented in a virtualized and/or containerized manner. For example, one or more of the elements of environment 800 may be implemented by one or more Virtualized Network Functions (“VNFs”), Cloud-Native Network Functions (“CNFs”), etc. In such embodiments, environment 800 may include, may implement, and/or may be communicatively coupled to an orchestration platform that provisions hardware resources, installs containers or applications, performs load balancing, and/or otherwise manages the deployment of such elements of environment 800. In some embodiments, such orchestration and/or management of such elements of environment 800 may be performed by, or in conjunction with, the open-source Kubernetes® application programming interface (“API”) or some other suitable virtualization, containerization, and/or orchestration system.

Elements of environment 800 may interconnect with each other and/or other devices via wired connections, wireless connections, or a combination of wired and wireless connections. Examples of interfaces or communication pathways between the elements of environment 800, as shown in FIG. 8, may include an N1 interface, an N2 interface, an N3 interface, an N4 interface, an N5 interface, an N6interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 8, such as SBIs, including an Namf interface, an Nudm interface, an Npcf interface, an Nupf interface, an Nnef interface, an Nsmf interface, and/or one or more other SBIs. In some embodiments, environment 800 may be, may include, may be implemented by, and/or may be communicatively coupled to network 105.

UE 101 may include a computation and communication device, such as a wireless mobile communication device that is capable of communicating with RAN 810, RAN 812, and/or DN 850. UE 101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 101 may send traffic to and/or receive traffic (e.g., user plane traffic) from DN 850 via RAN 810, RAN 812, and/or UPF/PGW-U 835.

RAN 810 may be, or may include, a 5G RAN that implements a 5G RAT and that includes one or more base stations (e.g., one or more gNBs 811), via which UE 101 may communicate with one or more other elements of environment 800. UE 101 may communicate with RAN 810 via an air interface (e.g., as provided by gNB 811). For instance, RAN 810 may receive traffic (e.g., user plane traffic such as voice call traffic, data traffic, messaging traffic, etc.) from UE 101 via the air interface, and may communicate the traffic to UPF/PGW-U 835 and/or one or more other devices or networks. Further, RAN 810 may receive signaling traffic, control plane traffic, etc. from UE 101 via the air interface, and may communicate such signaling traffic, control plane traffic, etc. to AMF 603 and/or one or more other devices or networks. Additionally, RAN 810 may receive traffic intended for UE 101 (e.g., from UPF/PGW-U 835, AMF 603, and/or one or more other devices or networks) and may communicate the traffic to UE 101 via the air interface.

RAN 812 may be, or may include, an LTE RAN that implements an LTE RAT and that includes one or more base stations (e.g., one or more eNBs 813), via which UE 101 may communicate with one or more other elements of environment 800. UE 101 may communicate with RAN 812 via an air interface (e.g., as provided by eNB 813). For instance, RAN 812 may receive traffic (e.g., user plane traffic such as voice call traffic, data traffic, messaging traffic, signaling traffic, etc.) from UE 101 via the air interface, and may communicate the traffic to UPF/PGW-U 835 (e.g., via SGW 817) and/or one or more other devices or networks. Further, RAN 812 may receive signaling traffic, control plane traffic, etc. from UE 101 via the air interface, and may communicate such signaling traffic, control plane traffic, etc. to MME 816 and/or one or more other devices or networks. Additionally, RAN 812 may receive traffic intended for UE 101 (e.g., from UPF/PGW-U 835, MME 816, SGW 817, and/or one or more other devices or networks) and may communicate the traffic to UE 101 via the air interface.

One or more RANs of environment 800 (e.g., RAN 810 and/or RAN 812) may include, may implement, and/or may otherwise be communicatively coupled to one or more edge computing devices, such as one or more Multi-Access/Mobile Edge Computing (“MEC”) devices (referred to sometimes herein simply as a “MECs”) 814. MECs 814 may be co-located with wireless network infrastructure equipment of RANs 810 and/or 812 (e.g., one or more gNBs 811 and/or one or more eNBs 813, respectively). Additionally, or alternatively, MECs 814 may otherwise be associated with geographical regions (e.g., coverage areas) of wireless network infrastructure equipment of RANs 810 and/or 812. In some embodiments, one or more MECs 814 may be implemented by the same set of hardware resources, the same set of devices, etc. that implement wireless network infrastructure equipment of RANs 810 and/or 812. In some embodiments, one or more MECs 814 may be implemented by different hardware resources, a different set of devices, etc. from hardware resources or devices that implement wireless network infrastructure equipment of RANs 810 and/or 812. In some embodiments, MECs 814 may be communicatively coupled to wireless network infrastructure equipment of RANs 810 and/or 812 (e.g., via a high-speed and/or low-latency link such as a physical wired interface, a high-speed and/or low-latency wireless interface, or some other suitable communication pathway).

MECs 814 may include hardware resources (e.g., configurable or provisionable hardware resources) that may be configured to provide services and/or otherwise process traffic to and/or from UE 101, via RAN 810 and/or 812. For example, RAN 810 and/or 812 may route some traffic from UE 101 (e.g., traffic associated with one or more particular services, applications, application types, etc.) to a respective MEC 814 instead of to core network elements of 800 (e.g., UPF/PGW-U 835). MEC 814 may accordingly provide services to UE 101 by processing such traffic, performing one or more computations based on the received traffic, and providing traffic to UE 101 via RAN 810 and/or 812. MEC 814 may include, and/or may implement, some or all of the functionality described above with respect to UPF/PGW-U 835, AF 830, one or more application servers, and/or one or more other devices, systems, VNFs, CNFs, etc. In this manner, ultra-low latency services may be provided to UE 101, as traffic does not need to traverse links (e.g., backhaul links) between RAN 810 and/or 812 and the core network.

AMF 603 may include one or more devices, systems, VNFs, CNFs, etc., that perform operations to register UE 101 with the 5G network, to establish bearer channels associated with a session with UE 101, to hand off UE 101 from the 5G network to another network, to hand off UE 101 from the other network to the 5G network, manage mobility of UE 101 between RANs 810 and/or gNBs 811, and/or to perform other operations. In some embodiments, the 5G network may include multiple AMFs 603, which communicate with each other via the N14 interface (denoted in FIG. 8 by the line marked “N14” originating and terminating at AMF 603).

MME 816 may include one or more devices, systems, VNFs, CNFs, etc., that perform operations to register UE 101 with the EPC, to establish bearer channels associated with a session with UE 101, to hand off UE 101 from the EPC to another network, to hand off UE 101 from another network to the EPC, manage mobility of UE 101 between RANs 812 and/or eNBs 813, and/or to perform other operations.

SGW 817 may include one or more devices, systems, VNFs, CNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, CNFs, etc., that gather, process, store, and/or provide information in a manner described herein. SMF/PGW-C 820 may, for example, facilitate the establishment of communication sessions on behalf of UE 101. In some embodiments, the establishment of communications sessions may be performed in accordance with one or more policies provided by PCF/PCRF 825.

PCF/PCRF 825 may include one or more devices, systems, VNFs, CNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, CNFs, etc., that receive, store, and/or provide information that may be used in determining parameters (e.g., quality of service parameters, charging parameters, or the like) for certain applications.

UPF/PGW-U 835 may include one or more devices, systems, VNFs, CNFs, etc., that receive, store, and/or provide data (e.g., user plane data). For example, UPF/PGW-U 835 may receive user plane data (e.g., voice call traffic, data traffic, etc.), destined for UE 101, from DN 850, and may forward the user plane data toward UE 101 (e.g., via RAN 810, SMF/PGW-C 820, and/or one or more other devices). In some embodiments, multiple instances of UPF/PGW-U 835 may be deployed (e.g., in different geographical locations), and the delivery of content to UE 101 may be coordinated via the N9 interface (e.g., as denoted in FIG. 8 by the line marked “N9” originating and terminating at UPF/PGW-U 835). Similarly, UPF/PGW-U 835 may receive traffic from UE 101 (e.g., via RAN 810, RAN 812, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

UDM/HSS 840 and AUSF 845 may include one or more devices, systems, VNFs, CNFs, etc., that manage, update, and/or store, in one or more memory devices associated with AUSF 845 and/or UDM/HSS 840, profile information associated with a subscriber. In some embodiments, UDM/HSS 840 may include, may implement, may be communicatively coupled to, and/or may otherwise be associated with some other type of repository or database, such as a Unified Data Repository (“UDR”). AUSF 845 and/or UDM/HSS 840 may perform authentication, authorization, and/or accounting operations associated with one or more UEs 101 and/or one or more communication sessions associated with one or more UEs 101.

DN 850 may include one or more wired and/or wireless networks. For example, DN 850 may include an Internet Protocol (“IP”)-based PDN, a wide area network (“WAN”) such as the Internet, a private enterprise network, and/or one or more other networks. UE 101 may communicate, through DN 850, with data servers, other UEs 101, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 101 may communicate.

External devices 854 may include one or more devices or systems that communicate with UE 101 via DN 850 and one or more elements of 800 (e.g., via UPF/PGW-U 835). External devices 854 may include, for example, one or more application servers 103, content provider systems, web servers, or the like. External devices 854 may, for example, implement “server-side” applications that communicate with “client-side” applications executed by UE 101. External devices 854 may provide services to UE 101 such as gaming services, videoconferencing services, messaging services, email services, web services, and/or other types of services. Operations described above with respect to a given external device 854 (e.g., in accordance with some embodiments) may be performed by a single device, by a cloud computing system, by one or more devices that implement a virtualized or containerized environment, a collection of devices, etc.

In some embodiments, external devices 854 may communicate with one or more elements of environment 800 (e.g., core network elements) via NEF/SCEF 849. NEF/SCEF 849 include one or more devices, systems, VNFs, CNFs, etc. that provide access to information, APIs, and/or other operations or mechanisms of one or more core network elements to devices or systems that are external to the core network (e.g., to external device 854 via DN 850). NEF/SCEF 849 may maintain authorization and/or authentication information associated with such external devices or systems, such that NEF/SCEF 849 is able to provide information, that is authorized to be provided, to the external devices or systems. For example, a given external device 854 may request particular information associated with one or more core network elements. NEF/SCEF 849 may authenticate the request and/or otherwise verify that external device 854 is authorized to receive the information, and may request, obtain, or otherwise receive the information from the one or more core network elements. In some embodiments, NEF/SCEF 849 may include, may implement, may be implemented by, may be communicatively coupled to, and/or may otherwise be associated with a Security Edge Protection Proxy (“SEPP”), which may perform some or all of the functions discussed above. External device 854 may, in some situations, subscribe to particular types of requested information provided by the one or more core network elements, and the one or more core network elements may provide (e.g., “push”) the requested information to NEF/SCEF 849 (e.g., in a periodic or otherwise ongoing basis).

In some embodiments, external devices 854 may communicate with one or more elements of RAN 810 and/or 812 via an API or other suitable interface. For example, a given external device 854 may provide instructions, requests, etc. to RAN 810 and/or 812 to provide one or more services via one or more respective MECs 814. In some embodiments, such instructions, requests, etc. may include QoS parameters, Service Level Agreements (“SLAs”), etc. (e.g., maximum latency thresholds, minimum throughput thresholds, etc.) associated with the services.

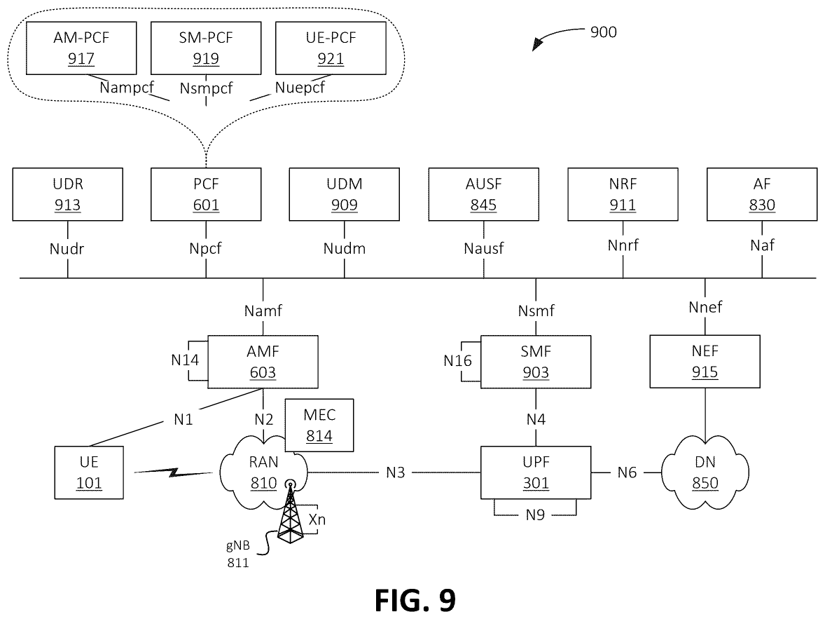

FIG. 9 illustrates another example environment 900, in which one or more embodiments may be implemented. In some embodiments, environment 900 may correspond to a 5G network, and/or may include elements of a 5G network. In some embodiments, environment 900 may correspond to a 5G SA architecture. In some embodiments, environment 900 may include a 5GC, in which 5GC network elements perform one or more operations described herein.

As shown, environment 900 may include UE 101, RAN 810 (which may include one or more gNBs 811 or other types of wireless network infrastructure) and various network functions, which may be implemented as VNFs, CNFs, etc. Such network functions may include AMF 603, SMF 903, UPF 301, PCF 601, UDM 909, AUSF 845, Network Repository Function (“NRF”) 911, AF 830, UDR 913, and NEF 915. Environment 900 may also include or may be communicatively coupled to one or more networks, such as DN 850.

The example shown in FIG. 9 illustrates one instance of each network component or function (e.g., one instance of SMF 903, UPF 301, PCF 601, UDM 909, AUSF 845, etc.). In practice, environment 900 may include multiple instances of such components or functions. For example, in some embodiments, environment 900 may include multiple “slices” of a core network, where each slice includes a discrete and/or logical set of network functions (e.g., one slice may include a first instance of SMF 903, PCF 601, UPF 301, etc., while another slice may include a second instance of SMF 903, PCF 601, UPF 301, etc.). Additionally, or alternatively, one or more of the network functions of environment 900 may implement multiple network slices. The different slices may provide differentiated levels of service, such as service in accordance with different QoS parameters.

The quantity of devices and/or networks, illustrated in FIG. 9, is provided for explanatory purposes only. In practice, environment 900 may include additional devices and/or networks, fewer devices and/or networks, different devices and/or networks, or differently arranged devices and/or networks than illustrated in FIG. 9. For example, while not shown, environment 900 may include devices that facilitate or enable communication between various components shown in environment 900, such as routers, modems, gateways, switches, hubs, etc. In some implementations, one or more devices of environment 900 may be physically integrated in, and/or may be physically attached to, one or more other devices of environment 900. Alternatively, or additionally, one or more of the devices of environment 900 may perform one or more network functions described as being performed by another one or more of the devices of environment 900.

Elements of environment 900 may interconnect with each other and/or other devices via wired connections, wireless connections, or a combination of wired and wireless connections. Examples of interfaces or communication pathways between the elements of environment 900, as shown in FIG. 9, may include interfaces shown in FIG. 9 and/or one or more interfaces not explicitly shown in FIG. 9. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 900 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 603), an Nudm interface (e.g., indicating communications to be routed to UDM 909), an Npcf interface, an Nupf interface, an Nnef interface, an Nsmf interface, an Nnrf interface, an Nudr interface, an Naf interface, and/or one or more other SBIs. In some embodiments, environment 900 may be, may include, may be implemented by, and/or may be communicatively coupled to network 105.

UPF 301 may include one or more devices, systems, VNFs, CNFs, etc., that receive, route, process, and/or forward traffic (e.g., user plane traffic). As discussed above, UPF 301 may communicate with UE 101 via one or more communication sessions, such as PDU sessions. Such PDU sessions may be associated with a particular network slice or other suitable QoS parameters, as noted above. UPF 301 may receive downlink user plane traffic (e.g., voice call traffic, data traffic, etc. destined for UE 101) from DN 850, and may forward the downlink user plane traffic toward UE 101 (e.g., via RAN 810). In some embodiments, multiple UPFs 301 may be deployed (e.g., in different geographical locations), and the delivery of content to UE 101 may be coordinated via the N9 interface. Similarly, UPF 301 may receive uplink traffic from UE 101 (e.g., via RAN 810), and may forward the traffic toward DN 850. In some embodiments, UPF 301 may implement, may be implemented by, may be communicatively coupled to, and/or may otherwise be associated with UPF/PGW-U 835. In some embodiments, UPF 301 may communicate (e.g., via the N4 interface) with SMF 903, regarding user plane data processed by UPF 301 (e.g., to provide analytics or reporting information, to receive policy and/or authorization information, etc.).

PCF 601 may include one or more devices, systems, VNFs, CNFs, etc., that aggregate, derive, generate, etc. policy information associated with the 5GC and/or UEs 101 that communicate via the 5GC and/or RAN 810. PCF 601 may receive information regarding policies and/or subscriptions from one or more sources, such as subscriber databases (e.g., UDM 909, UDR 913, etc.), and/or from one or more users such as, for example, an administrator associated with PCF 601. In some embodiments, the functionality of PCF 601 may be split into multiple network functions or subsystems, such as access and mobility PCF (“AM-PCF”) 917, session management PCF (“SM-PCF”) 919, UE PCF (“UE-PCF”) 921, and so on. Such different “split” PCFs may be associated with respective SBIs (e.g., AM-PCF 917 may be associated with an Nampcf SBI, SM-PCF 919 may be associated with an Nsmpcf SBI, UE-PCF 921 may be associated with an Nuepcf SBI, and so on) via which other network functions may communicate with the split PCFs. The split PCFs may maintain information regarding policies associated with different devices, systems, and/or network functions.

NRF 911 may include one or more devices, systems, VNFs, CNFs, etc. that maintain routing and/or network topology information associated with the 5GC. For example, NRF 911 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 913 may include one or more devices, systems, VNFs, CNFs, etc. that provide user and/or subscriber information, based on which PCF 601 and/or other elements of environment 900 may determine access policies, QoS policies, charging policies, or the like. In some embodiments, UDR 913 may receive such information from UDM 909 and/or one or more other sources.

NEF 915 include one or more devices, systems, VNFs, CNFs, etc. that provide access to information, APIs, and/or other operations or mechanisms of the 5GC to devices or systems that are external to the 5GC. NEF 915 may maintain authorization and/or authentication information associated with such external devices or systems, such that NEF 915 is able to provide information, that is authorized to be provided, to the external devices or systems. Such information may be received from other network functions of the 5GC (e.g., as authorized by an administrator or other suitable entity associated with the 5GC), such as SMF 903, UPF 301, a charging function (“CHF”) of the 5GC, and/or other suitable network function. NEF 915 may communicate with external devices or systems (e.g., external devices 854) via DN 850 and/or other suitable communication pathways.

While environment 900 is described in the context of a 5GC, as noted above, environment 900 may, in some embodiments, include or implement one or more other types of core networks. For example, in some embodiments, environment 900 may be or may include a converged packet core, in which one or more elements may perform some or all of the functionality of one or more 5GC network functions and/or one or more EPC network functions. For example, in some embodiments, AMF 603 may include, may implement, may be implemented by, and/or may otherwise be associated with MME 816; SMF 903 may include, may implement, may be implemented by, and/or may otherwise be associated with SGW 817; PCF 601 may include, may implement, may be implemented by, and/or may otherwise be associated with a PCRF (e.g., PCF/PCRF 825); NEF 915 may include, may implement, may be implemented by, and/or may otherwise be associated with a SCEF (e.g., NEF/SCEF 849); and so on.

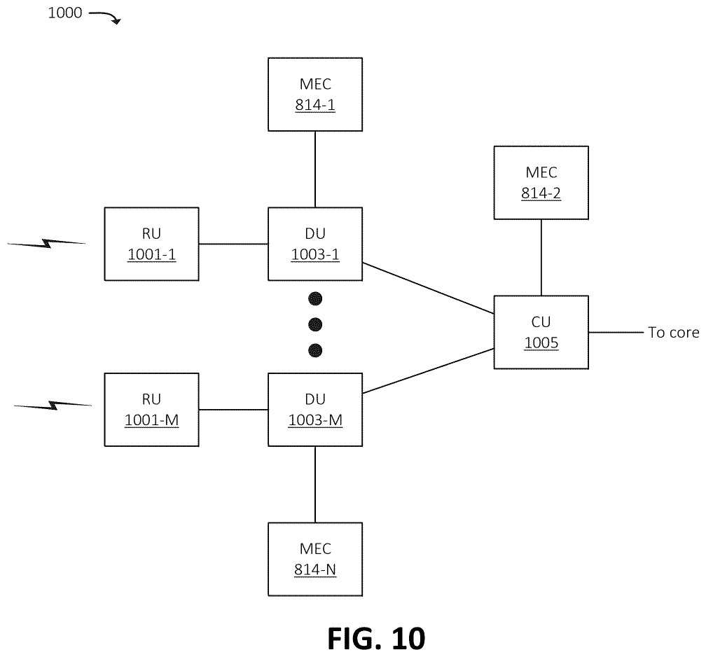

FIG. 10 illustrates an example RAN environment 1000, which may be included in and/or implemented by one or more RANs (e.g., RAN 810 or some other RAN). In some embodiments, a particular RAN 810 may include one RAN environment 1000. In some embodiments, a particular RAN 810 may include multiple RAN environments 1000. In some embodiments, RAN environment 1000 may correspond to a particular gNB 811 of RAN 810. In some embodiments, RAN environment 1000 may correspond to multiple gNBs 811. In some embodiments, RAN environment 1000 may correspond to one or more other types of base stations of one or more other types of RANs. As shown, RAN environment 1000 may include Central Unit (“CU”) 1005, one or more Distributed Units (“DUs”) 1003-1 through 1003-M (referred to individually as “DU 1003,” or collectively as “DUs 1003”), and one or more Radio Units (“RUs”) 1001-1 through 1001-M (referred to individually as “RU 1001,” or collectively as “RUs 1001”).

CU 1005 may communicate with a core of a wireless network (e.g., may communicate with one or more of the devices or systems described above with respect to FIG. 9, such as AMF 603 and/or UPF 301) and/or some other device or system such as MEC 814. In the uplink direction (e.g., for traffic from UEs 101 to a core network), CU 1005 may aggregate traffic from DUs 1003, and forward the aggregated traffic to the core network. In some embodiments, CU 1005 may receive traffic according to a given protocol (e.g., Radio Link Control (“RLC”) traffic) from DUs 1003, and may perform higher-layer processing (e.g., may aggregate/process RLC packets and generate Packet Data Convergence Protocol (“PDCP”) packets based on the RLC packets) on the traffic received from DUs 1003.

CU 1005 may receive downlink traffic (e.g., traffic from the core network, traffic from a given MEC 814, etc.) for a particular UE 101, and may determine which DU(s) 1003 should receive the downlink traffic. DU 1003 may include one or more devices that transmit traffic between a core network (e.g., via CU 1005) and UE 101 (e.g., via a respective RU 1001). DU 1003 may, for example, receive traffic from RU 1001 at a first layer (e.g., physical (“PHY”) layer traffic, or lower PHY layer traffic), and may process/aggregate the traffic to a second layer (e.g., upper PHY and/or RLC). DU 1003 may receive traffic from CU 1005 at the second layer, may process the traffic to the first layer, and provide the processed traffic to a respective RU 1001 for transmission to UE 101.

RU 1001 may include hardware circuitry (e.g., one or more RF transceivers, antennas, radios, and/or other suitable hardware) to communicate wirelessly (e.g., via an RF interface) with one or more UEs 101, one or more other DUs 1003 (e.g., via RUs 1001 associated with DUs 1003), and/or any other suitable type of device. In the uplink direction, RU 1001 may receive traffic from UE 101 and/or another DU 1003 via the RF interface and may provide the traffic to DU 1003. In the downlink direction, RU 1001 may receive traffic from DU 1003, and may provide the traffic to UE 101 and/or another DU 1003.

One or more elements of RAN environment 1000 may, in some embodiments, be communicatively coupled to one or more MECs 814. For example, DU 1003-1 may be communicatively coupled to MEC 814-1, DU 1003-M may be communicatively coupled to MEC 814-N, CU 1005 may be communicatively coupled to MEC 814-2, and so on. MECs 814 may include hardware resources (e.g., configurable or provisionable hardware resources) that may be configured to provide services and/or otherwise process traffic to and/or from UE 101, via a respective RU 1001.

For example, DU 1003-1 may route some traffic, from UE 101, to MEC 814-1 instead of to a core network via CU 1005. MEC 814-1 may process the traffic, perform one or more computations based on the received traffic, and may provide traffic to UE 101 via RU 1001-1. As discussed above, MEC 814 may include, and/or may implement, some or all of the functionality described above with respect to UPF 301, AF 830, and/or one or more other devices, systems, VNFs, CNFs, etc. In this manner, ultra-low latency services may be provided to UE 101, as traffic does not need to traverse DU 1003, CU 1005, links between DU 1003 and CU 1005, and an intervening backhaul network between RAN environment 1000 and the core network.

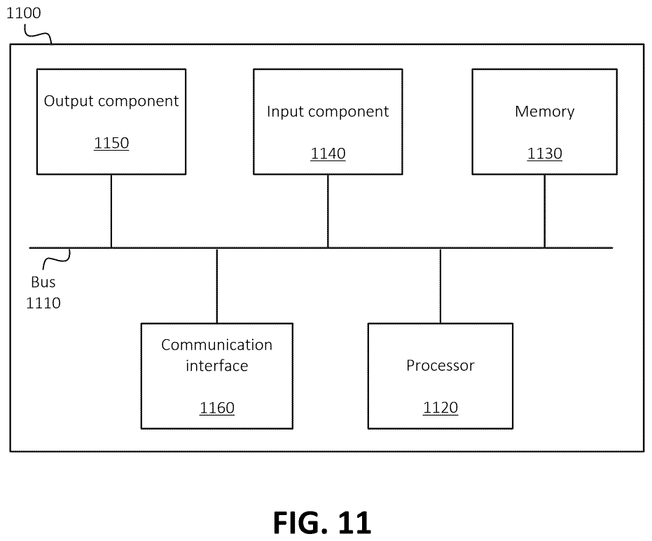

FIG. 11 illustrates example components of device 1100. One or more of the devices described above may include one or more devices 1100. Device 1100 may include bus 1110, processor 1120, memory 1130, input component 1140, output component 1150, and communication interface 1160. In another implementation, device 1100 may include additional, fewer, different, or differently arranged components.

Bus 1110 may include one or more communication paths that permit communication among the components of device 1100. Processor 1120 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1120 may be or may include one or more hardware processors. Memory 1130 may include any type of dynamic storage device that may store information and instructions for execution by processor 1120, and/or any type of non-volatile storage device that may store information for use by processor 1120.

Input component 1140 may include a mechanism that permits an operator to input information to device 1100 and/or other receives or detects input from a source external to input component 1140, such as a touchpad, a touchscreen, a keyboard, a keypad, a button, a switch, a microphone or other audio input component, etc. In some embodiments, input component 1140 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1150 may include a mechanism that outputs information to the operator, such as a display, a speaker, one or more light emitting diodes (“LEDs”), etc.

Communication interface 1160 may include any transceiver-like mechanism that enables device 1100 to communicate with other devices and/or systems (e.g., via RAN 810, RAN 812, DN 850, etc.). For example, communication interface 1160 may include an Ethernet interface, an optical interface, a coaxial interface, or the like. Communication interface 1160 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1100 may include more than one communication interface 1160. For instance, device 1100 may include an optical interface, a wireless interface, an Ethernet interface, and/or one or more other interfaces.

Device 1100 may perform certain operations relating to one or more processes described above. Device 1100 may perform these operations in response to processor 1120 executing instructions, such as software instructions, processor-executable instructions, etc. stored in a computer-readable medium, such as memory 1130. A computer-readable medium may be defined as a non-transitory memory device. A memory device may include space within a single physical memory device or spread across multiple physical memory devices. The instructions may be read into memory 1130 from another computer-readable medium or from another device. The instructions stored in memory 1130 may be processor-executable instructions that cause processor 1120 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-7), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
identify a first network slice, of a plurality of network slices of a wireless network, that serves a first communication session associated with a User Equipment (“UE”) that is communicatively coupled to the wireless network, wherein the first communication session is associated with a particular identifier;
identify a particular set of traffic attributes associated with a slice re-routing policy;
identify that the slice re-routing policy indicates a second network slice, of the plurality of network slices, that is different from the first network slice; and
output the slice re-routing policy to the UE based on identifying that the slice re-routing policy indicates the different second network slice, wherein providing the slice re-routing policy includes outputting:
the particular set of traffic attributes, and
an indication of the second network slice,
wherein the UE outputs uplink traffic, that meets the particular set of traffic attributes, via a second communication session that is associated with the second network slice, wherein the UE further includes the particular identifier with the uplink traffic.

2. The device of claim 1, wherein the particular identifier is a first identifier, the second communication session is associated with a second identifier, and the uplink traffic includes the first identifier and the second identifier.

3. The device of claim 1, wherein the particular identifier includes a particular Internet Protocol (“IP”) address.

4. The device of claim 3, wherein the particular IP address is assigned as part of an establishment procedure of the first communication session.

5. The device of claim 1, wherein the one or more processors are further configured to output the slice re-routing policy to a User Plane Function (“UPF”) of the wireless network.

6. The device of claim 5, wherein the UPF outputs downlink traffic, that meets the particular set of traffic attributes, via the second communication session that is associated with the second network slice.

7. The device of claim 1, wherein the particular set of traffic attributes includes at least one of:
a destination IP address of the uplink traffic,
a protocol of the uplink traffic, or
a service type of the uplink traffic.

8. A non-transitory computer-readable medium, storing a plurality of processor-executable instructions to:
identify a first network slice, of a plurality of network slices of a wireless network, that serves a first communication session associated with a User Equipment (“UE”) that is communicatively coupled to the wireless network, wherein the first communication session is associated with a particular identifier;
identify a particular set of traffic attributes associated with a slice re-routing policy;
identify that the slice re-routing policy indicates a second network slice, of the plurality of network slices, that is different from the first network slice; and
output the slice re-routing policy to the UE based on identifying that the slice re-routing policy indicates the different second network slice, wherein providing the slice re-routing policy includes outputting:
the particular set of traffic attributes, and
an indication of the second network slice,
wherein the UE outputs uplink traffic, that meets the particular set of traffic attributes, via a second communication session that is associated with the second network slice, wherein the UE further includes the particular identifier with the uplink traffic.

9. The non-transitory computer-readable medium of claim 8, wherein the particular identifier is a first identifier, the second communication session is associated with a second identifier, and the uplink traffic includes the first identifier and the second identifier.

10. The non-transitory computer-readable medium of claim 8, wherein the particular identifier includes a particular Internet Protocol (“IP”) address.

11. The non-transitory computer-readable medium of claim 10, wherein the particular IP address is assigned as part of an establishment procedure of the first communication session.

12. The non-transitory computer-readable medium of claim 8, wherein the plurality of processor-executable instructions further include processor-executable instructions to output the slice re-routing policy to a User Plane Function (“UPF”) of the wireless network.

13. The non-transitory computer-readable medium of claim 12, wherein the UPF outputs downlink traffic, that meets the particular set of traffic attributes, via the second communication session that is associated with the second network slice.

14. The non-transitory computer-readable medium of claim 8, wherein the particular set of traffic attributes includes at least one of:
a destination IP address of the uplink traffic,
a protocol of the uplink traffic, or
a service type of the uplink traffic.

15. A method, comprising:
identifying a first network slice, of a plurality of network slices of a wireless network, that serves a first communication session associated with a User Equipment (“UE”) that is communicatively coupled to the wireless network, wherein the first communication session is associated with a particular identifier;
identifying a particular set of traffic attributes associated with a slice re-routing policy;
identifying that the slice re-routing policy indicates a second network slice, of the plurality of network slices, that is different from the first network slice; and
outputting the slice re-routing policy to the UE based on identifying that the slice re-routing policy indicates the different second network slice, wherein providing the slice re-routing policy includes outputting:
the particular set of traffic attributes, and
an indication of the second network slice,
wherein the UE outputs uplink traffic, that meets the particular set of traffic attributes, via a second communication session that is associated with the second network slice, wherein the UE further includes the particular identifier with the uplink traffic.

16. The method of claim 15, wherein the particular identifier is a first identifier, the second communication session is associated with a second identifier, and the uplink traffic includes the first identifier and the second identifier.

17. The method of claim 15, wherein the particular identifier includes a particular Internet Protocol (“IP”) address that is assigned as part of an establishment procedure of the first communication session.

18. The method of claim 15, further comprising output the slice re-routing policy to a User Plane Function (“UPF”) of the wireless network.

19. The method of claim 18, wherein the UPF outputs downlink traffic, that meets the particular set of traffic attributes, via the second communication session that is associated with the second network slice.

20. The method of claim 15, wherein the particular set of traffic attributes includes at least one of:
a destination IP address of the uplink traffic,
a protocol of the uplink traffic, or
a service type of the uplink traffic.
